(19) United States
(12) Patent Application Publication
(10) Pub. No.: US 2004/0008672 A1
(43) Pub. Date: Jan. 15, 2004

(54) Wireless telephone usage management

(75) Inventors: Daniel E. Kobylarz, Bloomington, MN (US); Eric M. Dahlen, Las Vegas, NV (US)

Correspondence Address: E. J. Brooks & Associates, PLLC, Suite 500, 1221 Nicollet Avenue, Minneapolis, MN, 55403, US

(73) Assignee: Teledigital, Inc.

(21) Appl. No.: 10/617,097

(22) Filed: Jul. 10, 2003

Related U.S. Application Data
(60) Provisional application No. 60/395,255, filed on Jul. 15, 2002.
(60) Provisional application No. 60/395,454, filed on Jul. 15, 2002.
(60) Provisional application No. 60/395,455, filed on Jul. 15, 2002.

(51) Int. Cl. H04L 12/66

(52) U.S. Cl. 370/352; 370/310

(57) ABSTRACT

Method, system, and device embodiments including a wireless device having a processor, a memory in communication with the processor, and a transceiver are provided. The transceiver is in communication with the processor and is operable to transmit and receive information via a wireless connection. The device is operable to provide a wireless connection based upon a plan having a predetermined number of available units. The plan usage is tracked by a provider through use of a calculation method utilizing unit calculations that are not equal to exact time usage to decrement available units. The device is operable to emulate the calculation method of the provider in order to track the remaining available units on the device.

The application claims priority to U.S. Provisional Application Serial Nos. 60/395,255, 60/395,454, and 60/395,455, filed Jul. 15, 2002, the specifications of which are incorporated herein by reference.

Current pre-paid and post-paid wireless device technology utilizes the connection of the device to a wireless communication network for connection to other wireless or wired devices. This access to the wireless network is often provided from a provider in the form of a plan, wherein the plan allows the device to access the network for a certain number of units of time and the access is controlled by the provider.

The units of time may be in standard time increments, such as seconds, minutes, hours, and the like, or can be in other forms such as amounts of currency, wherein each connection has a rate. These plans for example, can be 300 minutes, or $100 worth of access time.

Additionally, in some plans different types of access can have different values. For example, access for voice communication can have one rate and data communication can have another rate, or a local connection can have a first rate and long distance connections have a different rate.

Providers also often round the time either up and/or down if the device is disconnected from the network between full time increments. For example, the provider often rounds up to the nearest minute if a device is disconnected between increments (e.g. a connection lasting 1 minute and 1 second can be rounded to 2 minutes).

Since the provider is controlling the access of the device to the network, the provider keeps track of the calculations of access time remaining and may restrict the device when the time has run out. In a post paid context, the device is not restricted, but rather, the provider raises the rate for connection time that is over the time limit of the plan.

Some devices have tried to track the amount of time used, by recording the time the device is in communication on the network. However, if the provider is charging by dollar amount or by multiples of units that equal more than one time increment (e.g. one minute) then the user may not know exactly when their time on the plan will expire or has expired. This can result in connections being cut off abruptly or higher rates being incurred without the user's knowledge.

The tracking of when a device is roaming is another problem that exists in the industry. Roaming areas are established by the provider and if the provider is controlling the access of the device to the network, it can identify when a device is in a roaming area and adjust its billing rate for that access accordingly. However, when the device controls the access to the network, then the device must know the areas that the provider considers to be roaming areas. However, the list of roaming areas is not generally accessible for purposes of billing for roaming usage on the device. In order to allow for the billing of roaming units on the device, a different list of roaming areas has traditionally been needed.

Additionally, in the area of post-paid wireless services, the devices have been able to utilize a plan having predetermined sets of units for specific time periods. For example, one plan offers a number of minutes for nights and weekends and a second number of units for anytime during the week. These plans are typically offered to provide an incentive to use the units on nights and weekends. For example, one plan offers 300 anytime units and 3000 night and weekend units. In this way, the user may choose to make connections on nights and weekends since they have so many more available units. Devices in the area of pre-paid wireless services have not been capable of providing these plans to users and to accurately track the amount of units remaining in each category of the plan.

Further, in determining the rate for a given connection to a wireless network, traditionally the rate has been determined by a complex billing algorithm wherein portions of the identification code (e.g. telephone number) are run through the algorithm to determine what type of communication it is. For example, a telephone number can be identified as local or long distance by utilizing a complex billing algorithm. The basic complex billing algorithm differentiates local, long distance, international, and roaming connections from each other and can act to combine connection types if a connection is, for example, both roaming and long distance. However, this method requires precise programming of definitions to ensure that call rating or billing is accurate.

### BRIEF DESCRIPTION OF THE DRAWINGS

FIG. 1 is a diagram of a system embodiment illustrating a device communicating with a wireless connection provider.

FIG. 2 illustrates the components of a device embodiment.

FIG. 3 illustrates a method embodiment for emulating a wireless provider's post paid plan on a pre-paid device.

FIG. 4 illustrates a method embodiment for determining the classification of a wireless communication.

FIG. 5 illustrates another method embodiment for determining the classification of a wireless communication.

### DETAILED DESCRIPTION

Embodiments of the present invention provide devices, systems, and methods for conducting wireless communication on a communication network hose skilled in the art will understand that the embodiments disclosed herein re applicable to both pre-paid and post-paid plans unless such a limitation is explicitly stated. Those skilled in the art will understand that in reading this disclosure and claims, it should be noted that the indefinite article “a” or “an” as it is used herein is not intended to limit the number of elements to one. Additionally, it should be noted that the term “a number of” is understood to include one or more elements.

In one embodiment, a wireless device is operable to provide a wireless connection based upon a plan having a number of available units. As stated above, the units can be any unit of measure. For example, units can be equivalent to standard units of time such as seconds, minutes, hours, etc. or can be multiples of units of time, such as 2 units per minute, or 0.75 units per minute, etc. Units can also be portions of a complete standard unit, such as 1/10 of a second, and the like.

In various embodiments, a provider tracks plan usage through the use of a calculation method. The calculation method generally takes the time that a device was connected to the network and determines what the cost of that time will be in units. The determined number of units is then decremented from the number of units that are available to the device. Determining the amount of units to decrement can be accomplished in many ways. For example, a minute of time can be equal to one unit. Further, any partial minutes can be rounded up and/or down to the next full minute.

Additionally, as stated above, fractions or integer multiples of units can be utilized to calculate the number of units that the provider will decrement from the number of available units. For example, a local connection can cost 0.10 units per minute, while the charge for a long distance connection could be 2 units per minute.

These charges can also be additive, such that the device is decremented 2.1 units for a long distance connection because the device is being charged 0.10 units per minute for local access to the network and 2 units per minute for the long distance connection.

Further, there may be different methods of calculating different types of connections or for different volumes of time that have been purchased, among other things. For example, for example some connections could be on a time increment basis and some could be based on a fixed fee or could have a surcharge applied to the fee. Additionally, time could be purchased in a block of, for example, 100 units at 35 cents per minute and can be purchased in a 300 minute block at 25 cents per minute. The units in these two blocks can be tracked together in a single account having units therein or separately.

An example of a fixed rate can be where, once the device is connected, a single fee is assessed instead of a fee per time period. For example, when a directory assistance service is contacted, the user could be charged a single fee while they are getting their information. Additionally, connection to a customer service center could be a fixed rate or could be fixed as a free connection.

A surcharge fee is a fee where the user is charged a one time fee for connection. The user can then be charged a standard rate, e.g. 15 cents/minute, for the time that the device is connected.

The above examples illustrate situations in which a provider may not use a calculation method that utilizes unit calculations that are equal to the exact measurement of the time usage to decrement the units available to the device.

In various embodiments, the device can be operable to emulate the calculation method of the provider in order to track the remaining available units on the device. This allows a user to be able to more accurately monitor the amount of units the device has available.

The emulation can be accomplished by, for example, providing one or more calculation methods on the device and using the calculation method to calculate the remaining available units along with the provider, but through a separate, parallel computation on the device.

If more than one calculation method is provided, then the user or device can choose the method that corresponds to the one or more methods used by the provider. In this way, the device can be switched from one provider to another, if the calculation method for each provider is accessible by the device. The providing of the calculation method can be accomplished by either wired or wireless transmission of the information to the device and can be done, for example, by a manufacturer of a wireless device, a reseller of wireless devices, a reseller of a wireless connection, or by a direct provider of a wireless connection, and can be done initially such as when the device is configured for use and/or by periodic updates.

Through use of the calculation method on the device, the device can be utilized to control access of the network and can provide accurate information to the user about the amount of time remaining under their plan. If the device is operable to restrict (e.g. limit or block) the access of the device to the network, the device can also be operable to accept new units to replenish the number of available units and to allow the device to unrestrict the access of the device to the network. The opening of access to the network can be accomplished in several ways including, but not limited to, allowing the device to open the access. Another way to open access to the wireless connection is by communicating with a provider to open the access, among others. A provider can open access, for example at a Home Location Register (HLR) on a cellular circuit switch network, or at an Authentication, Authorization, and Accounting (AAA) component in an IP packet switch network, among others.

In various embodiments, the provider defines the areas in which a device will be considered home, in an extended region, or roaming. In these areas, the provider has created information that it sends and stores on the device for the device to determine that it is roaming. The information is typically sent to the device in the form of a provider roaming list, sometimes called a preferred roaming list or roaming list. Some or all of this information can be interpreted or use by the calculation method of the device to allow the device to determine that it is roaming for the purposes of applying a roaming rate to its calculation method. For example, in one embodiment, the provider provides roaming characteristics indicating the area in which the device is located, its acquisition type, and roaming indicator, among others. In various embodiments, one or more of these characteristics can be utilized to indicate when the device is connected to the network and is roaming.

In various embodiments, the device can also be operable to transmit and receive a first type of wireless communication, such as local telephone calls and transmit and receive a second type of wireless communication, such as long distance telephone calls to a single provider. In some embodiments, the device can also be operable to transmit and receive a first type of wireless communication, such as local telephone calls through a first provider, and transmit and receive a second type of wireless communication, such as long distance telephone calls through a second provider. In this embodiment, since there are two providers, the device can be operable to individually track the remaining units available for connection to each provider. The types of communication can be types of telephone connection such as local or long distance. They can also be voice, data, video, or other types of communication. In some embodiments, the device can be operable to emulate the calculation method of one or both providers. In some embodiments, one or both providers can update the device as to the number of available units. This can be accomplished in any manner of transmission. For example, the provider can send a Short Message Service (SMS) Message to update the amount of units available.

In some embodiments, the device can reserve or assign a certain amount of time either in addition to the units assigned by a plan, or from those units assigned by a plan. This is useful, for example, when a provider has a set billing period and the user obtains plan units with only a portion of the billing period left. In this case, the device can allocate a number of units to be used during the remainder of the billing period. The units can either be deducted from the number of plan units assigned, or can be billed for separately, with the assigned units becoming reserved to be available when the new billing period begins.

In various embodiments, units can be added to the device before the currently held units have been used or have expired. In some embodiments, the units can be banked in a single account and the new units are added to the currently held units. In some embodiments, the units can be held in separate accounts.

Those skilled in the art will understand that the device can be operable to have separate accounts based on one or more of a variety of different criteria. The criteria can be of any suitable kind. One type of suitable criteria are, time periods. For example units in a current billing period are in one account and units reserved for a future billing period are in another account.

Another type of suitable criteria are numbers of units that are assigned in bulk. For example, the first 300 units assigned have one rate and the second 300 units assigned have another rate. Another type of suitable criteria are units for different types of connections. For example, the units can be organized into accounts for connect types such as telephone access, Internet access, and SMS messaging, among other.

Another type of suitable criteria are units for different services, such as units for friends and family and mobile to mobile connection services. Another type of criteria that can be utilized are units having different rates. For example, units at 3 cents per minute are organized into one account and units at 5 cent per minute are organized into another account), among others.

In various embodiments, once an account has no available units remaining, the device can restrict access to the feature associated with the account, or can bill separately for the usage of the feature. For example, a user can add units for Internet access to an Internet access account that holds the units to be decremented when usage of the Internet access feature is recorded. Once all of the units in the account have been used or have expired, the feature can be restricted from use or the user can be billed separately for the usage. In this way, the user can add and remove features from the device.

In various embodiments, the user can have a cash account that holds funds for paying for features without having a separate account for each individual feature. In this way, the all of the features of the device can be used without dedicating funds to each feature. The cash account can also be used to pay for usage of a feature after the account for the feature has been decremented to zero units. The cash account can have units or money held in the account and the device can be operable to allow the cash account to be accessed manually or automatically, to possibly avoid the interruption of service. The device can also have credit information thereon for accessing personal monetary accounts such as a checking account, savings account, and/or a credit card account to add money from a monetary accounts to the cash account or purchase other functions, connection plans, connection time, and/or access to features on the device such as Internet access, SMS messaging and the like.

Those skilled in the art will understand that units can be categorized in any manner. For example, categories can include, but are not limited to night and weekend, anytime, night, day, friend and family, mobile to mobile, holiday, and weekend, among many others. Units can also be categorized to include multiple rate structures such as a number of rates for city, state, national, international, and the like.

In various embodiments, the device can be operable to switch from one rate to another rate based on a switch from one category to another. For example, a device can be connected and be billed on anytime units within an anytime account, but when the time interval transitions from anytime to a time within the night and weekend category, the device can be operable to automatically switch to the night and weekend account and decrement units from hat account, or can change the rate charged to the single account.

As one of ordinary skill in the art will understand, the embodiments can be performed by software, firmware, application modules, and computer executable instructions operable on the systems and devices shown herein or otherwise. The invention, however, is not limited to any particular operating environment or to software written in a particular programming language. Software, application modules and/or computer executable instructions, suitable for carrying out embodiments of the present invention, can be resident in one or more devices or locations or in several and even many locations.

Unless explicitly stated, the method embodiments described herein are not constrained to a particular order or sequence. Additionally, some of the described method embodiments can occur or be performed at the same point in time.

As one of ordinary skill in the art will appreciate upon reading this disclosure, various embodiments of the invention can be performed in one or more devices, device types, and system environments including networked environments. The discussion which follows illustrates, by way of example and not by way of limitation, various network and system environments and devices that implement or include embodiments of the present invention.

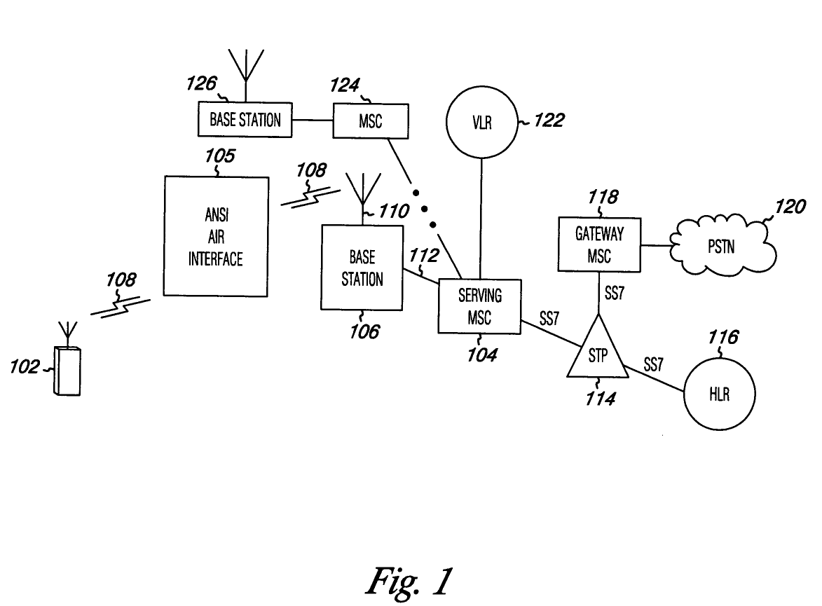

FIG. 1 is a diagram of a system embodiment illustrating a device communicating with a wireless connection provider. FIG. 1 is a block diagram of a network illustrating a device 102 communicating with a switching center (MSC) 104.

One example of a network, or control network, includes an IS-41/CDMA network. System configuration and operation of a code division multiple access (CDMA) cellular communications system is well known to those skilled in the art. Accordingly, detailed information concerning CDMA system configuration and operation is not provided. However, technical information concerning this topic may be obtained by referring to a number of available documents. For example, for a description of the use of CDMA techniques in a multiple access communications system, reference is made to U.S. Pat. No. 4,901,307, entitled “Spread Spectrum Multiple Access Communication System Using Satellite or Terrestrial Repeaters.”

Furthermore, for a description of the generation of signal waveforms for use in a CDMA communications system, reference is made to U.S. Pat. No. 5,103,459, entitled “System and Method for Generating Signal Waveforms in a CDMA Cellular System” and U.S. Pat. No. 5,883,888, entitled “Seamless Soft Handoff in a CDMA Cellular Communications System.” The disclosures of the foregoing references are expressly incorporated by reference herein.

The heart of a typical wireless telecommunications system is the MSC that is connected to a plurality of base stations that are dispersed throughout the geographic area serviced by the system. The geographic area serviced by a wireless telecommunications system is partitioned into a number of spatially distinct areas called “cells.” Each MSC is responsible for, among other things, establishing and maintaining connections between devices and between a device and a wireline terminal, which is connected to the system via the local and/or long-distance networks. An MSC is a switch specialized for wireless and mobility support. An MSC performs various functions, including mobility management, connection handoffs, connection admission, connection control, resource allocation, and so forth. The connection is then relayed from the MSC to base stations and via wireless communications to the device.

In FIG. 1, whenever the device 102 activates or roams into a new MSC coverage area, i.e., the “cell” for which the MSC is responsible, the new MSC becomes the serving MSC. The device transmits its stored identity to the new serving MSC via a base station 106. As shown in FIG. 1, the subscriber identity information is transmitted over a radio channel 108 in a format compliant with an air interface standard 105, e.g. ANSI/IS-41, and detected by an antenna 110 of base station 106.

As shown in FIG. 1, base station 106, in turn, can transmit the subscriber identity information to the serving MSC 104, such as for example via communication line 112. The procedures and protocol for communication between the base station 106 and the MSC 104 have also been standardized. For an identification of industry standards relating to these communications, reference is made to TIA/EIA/IS634-A, “MSC-BS Interface for Public Wireless Communication Systems.”

In the embodiment shown in FIG. 1, in order to provide service to the newly registered device 102, the serving MSC 104 transmits a Mobile Application Part (MAP) based signal, such as a registration notification signal (IS-41 message) or location update signal (GSM message), to a home location register (HLR) 116 via a signaling link such as a signal transfer point (STP) 114. An STP is a node, for example, in the signaling system 7 (SS7) networks that routes messages between exchanges and between exchanges and databases that hold subscriber and routing information. An HLR is one such database in a cellular system that contains all the subscribers within the provider's home service area. The data in the HLR is requested and transferred via SS7 to a VLR in the new area.

In the embodiment of FIG. 1, the STP 114 routes the MAP based signal to a gateway MSC 118. As shown in FIG. 1, the gateway MSC 118 can serve as a network switch for connecting to the public switched telephone network (PSTN) 120. SS7 is the protocol used in the PSTN for setting up connections and providing services. The SS7 network sets up and tears down the connection, handles all the routing decisions and supports all modern connection services, such as local number portability (LNP), among others. (LNP allows a telephone subscriber to port his/her phone number when that subscriber relocates to a different region of the country, even when the local area code may be different.)

The MAP based signal informs the HLR 116 of the network address associated with the MSC 104 currently serving the device 102 and also request requisite subscriber information for providing service to the mobile device 102. The HLR 116 updates its database to store the network address representing the serving MSC 104 and also copies the requested subscriber information to the VLR 122 associated with the serving MSC 104. The network address representing the serving MSC 104 stored in the HLR 116 is later utilized by the network to reroute any incoming connection intended for the device 102 to the serving MSC 104.

Accordingly, whenever a telecommunications subscriber dials a telephone number for the device 102, the HLR 116 is queried by the network to determine the current location of the device 102. Utilizing the stored network address in HLR 116 representing the serving MSC 104, the HLR 116 requests a roaming number from the serving MSC 104 in response to the receipt of the query signal. The roaming number provided by the serving MSC 104 is then used by the telecommunications network to route the incoming signal towards the serving MSC 104. The serving MSC 104 then pages the device 102 and accordingly establishes a voice connection with the device 102, if available.

If the device 102 roams out of serving MSC 104 coverage area and into another MSC 124 coverage area, MSC 104 will hand-off the communication to MSC 124 and base station 126. To ensure compatibility between two MSCs, the procedures and protocol for the format and transmission of messages have been standardized. For an identification of industry standards relating to these communications, reference is made to ANSI/IS-41, “Cellular Radio telecommunications Intersystem Operations.”

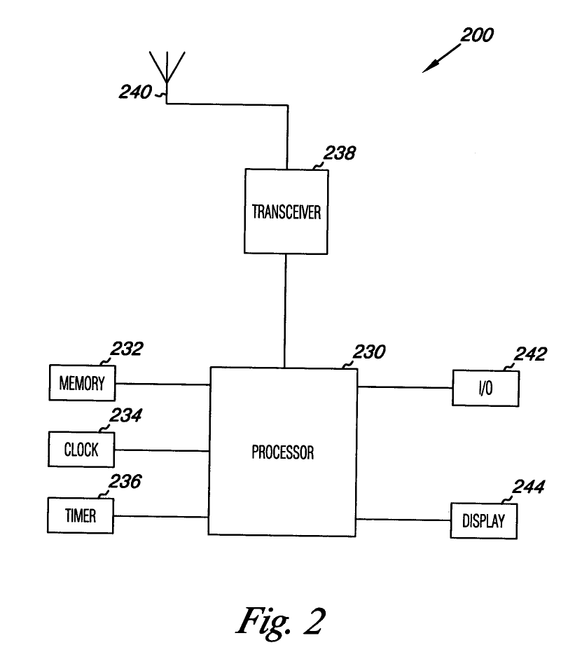

FIG. 2 illustrates the components of a device embodiment. In various embodiments, the device 200 can include a processor and/or application module 230, a memory 232, a clock 234, a timer 236, a transceiver 238, an antenna 240, an I/O port 242, and a display 244. The processor and/or application module 230 are operable on computer readable instructions for processing information and data as the same will be known and understood by one of ordinary skill in the art.

The device 200 can be utilized to transmit and receive voice and data information on the same or different connections. The device can be operable to transmit and receive information from any type of wireless network. Sources of the information can be from other wired or wireless devices, and can include voice, data (including message data, Internet data, and the like), and video information among other media types. Additionally, the voice and data connections can be calculated using the same, similar, or different calculation methods and can be assigned different units or decrement from the same set of available units.

In various embodiments, the device 200 can be operable to be switched between post-paid and pre-paid platforms. This can be accomplished, for example, by modifying or replacing the software or firmware within the device. In some embodiments, the modification or replacement can be done by wireless or wired transmission of data to the device. This allows the device to be configurable to both platforms and, therefore, reduces the amount of inventory that a manufacturer or reseller needs to maintain. Those skilled in the art will understand that the term platform as used herein is intended to denote a wireless network operating according to a particular protocol or set of business rules. Examples of platforms include, but are not limited to networks that are operable to have wireless connection access controlled from the device and networks that are operable to have access controlled by the provider.

In various embodiments, the device 200 can be operable to maintain usage records, such as connection detail including, but not limited to connection requested, duration of connection, rate of connection, and the like. The device can be operable to allow access to the records on the device by the provider, or can be operable to transmit the information to the provider. This feature enables the provider to verify details of a connection, for example, if the user disputes any details, and allows the provider to analyze any number of statistics either for a single device or for multiple devices based upon the information.

The memory, such as that shown at 232 of FIG. 2, can be utilized to hold software such as computer executable instructions for carrying out the present invention. Memory, as the same is used herein, can include any suitable memory for implementing the various embodiments of the invention. Memory can include fixed memory and/or portable memory.

Examples of memory types include Non-Volatile (NV) memory (e.g. Flash memory), RAM, ROM, magnetic media, and optically read media and includes such physical formats as memory cards, memory sticks, memory keys, CDs, DVDs, hard disks, and floppy disks, to name a few. The invention, however, is not limited to any particular type of memory medium. One of ordinary skill in the art will appreciate the manner in which software, e.g. computer readable instructions, can be stored on a memory medium.

The clock 234 can be used to provide the time of day in a given location. The clock 234 may be provided on the device 200 or the clock 234 can be located on a provider. The timer 236 can be operable to register the rate of duration of a wireless connection. Information provided by the clock 234 and the timer 236 can be operated on by a set of computer executable instructions for performing the calculation method. In some embodiments, the clock's time can be synchronized with the clock utilized by the provider. In some embodiments, the time used for tracking and calculation can be transmitted from the provider and the clock 234 and timer 236 on the device 200 are not necessary. Those skilled in the art will understand that the calculation method can be performed by software, firmware, and the like.

The transceiver 238 can be utilized to send and receive information and can thereby be operable to connect the device 200 to the wireless network. Those skilled in the art will understand that the transceiver can be connected to an antenna 240. Those skilled in the art will also understand that the transceiver 238 can be a single component or can be a number of components, such as a transmitter and a receiver.

As shown in FIG. 2, the device can also have a number of I/O ports 242. 1/0 ports 242 can be utilized to connect elements such as keyboards, speakers, microphones, and displays, among others. In the embodiment shown in FIG. 2, a display 244 is provided on the device 200, via a built in interface. Those skilled in the art will understand that other elements, such as those described above, can be attached in this manner.

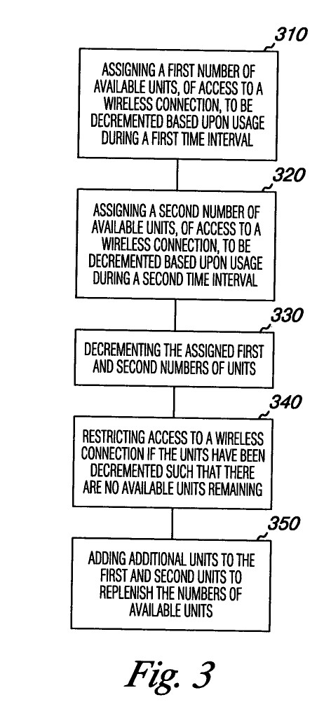

FIG. 3 illustrates a method embodiment for emulating a wireless provider's post paid plan on a pre-paid device. In the embodiment shown in FIG. 3, the method includes assigning a first number of available units, of access to a wireless connection, to be decremented based upon usage during a first time interval at block 310. In various embodiments, the first time interval can be for anytime communication.

The method illustrated in FIG. 3 also includes assigning a second number of available units, of access to a wireless connection, to be decremented based upon usage during a second time interval at block 320. In various embodiments, the second time interval can be within the first time interval. In various embodiments, the second time interval can be for night and weekend communication.

The method shown in FIG. 3 also includes decrementing the assigned first and second numbers of units according to a set of computer executable instructions at block 330. As described herein the set of computer executable instructions decrements according to a calculation method which emulates a wireless provider's post-paid plan on a pre-paid device. Those skilled in the art will understand from reading this disclosure that the first and second numbers of units can be decremented independently.

The method shown in FIG. 3 also includes restricting access to a wireless connection if the at least the first units have been decremented to zero at block 340. In some embodiments, the device restricts use of the device with respect to use of the first number of units when the first number of units is decremented to zero. In some embodiments, even though the first number of units is decremented to zero, the device can still be used with respect to the second number of units if units are available.

The method illustrated in FIG. 3, also includes adding additional units to the first and second units to replenish the numbers of available units at block 350. In various embodiments, units can be added to a single set of units, such as the first number of units. In some embodiments, the units can be added in a plan such that the ratios of units in the different plan categories is maintained.

In various embodiments, adding additional units to the first and second units to replenish the numbers of available units can include adding units before the first and second units have been decremented to zero. In some embodiments, the method can include holding the additional units in a separate account until a billing date passes and then adding the additional units to the first and second units.

In various embodiments, the method can also includes decrementing the numbers of first and second units to zero after a period of time has passed since the units were assigned.

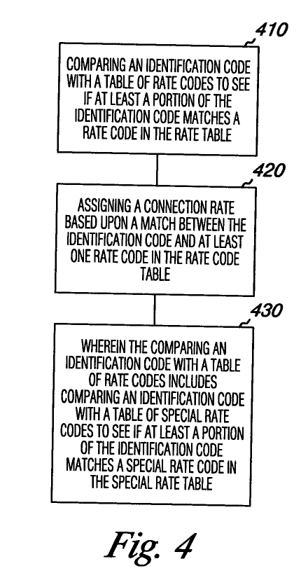

FIG. 4 illustrates a method embodiment for determining the classification of a wireless communication. In the embodiment shown in FIG. 4, the method includes comparing an identification code with a table of rate codes to see if at least a portion of the identification code matches a rate code in the rate table at block 410. The identification codes can be of any type. For example, identification codes can be telephone numbers, Internet addresses, alphanumeric codes, and the like.

In various embodiments, comparing an identification code with a table of rate codes can include comparing the identification code with a table of blocking codes to see if at least a portion of the identification code matches a blocking code in the blocking code table. In various embodiments, comparing an identification code with a table of rate codes can include comparing the identification code with a table of home area codes to see if at least a portion of the identification code matches a home area code in the home area code table. In various embodiments, the identification code can have a number of digits and the rate codes can have a number of digits and wherein a sequence of digits within the identification code are compared to see if the sequence of digits in the identification code match a sequence of digits in at least one rate code.

The method illustrated in FIG. 4 also includes assigning a connection rate based upon a match between the identification code and at least one rate code in the rate code table at block 420. In the embodiment illustrated in FIG. 4, the method also provides comparing an identification code with a table of special rate codes to see if at least a portion of the identification code matches a special rate code in the special rate table at block 430.

In various embodiments, the method illustrated in FIG. 4 can also include comparing a system identification code with a table of home identification codes to see if at least a portion of the system identification code matches a home identification code in the home identification code table. The system identification code is provided, by the provider, within the wireless connection and is monitored by the device so that the device knows when the device is switching from one system to another. For example, the device can switch from one system to another when a wireless communication switches from one base station to another within a wireless network. The system identification code is compared with the home identification code table to determine whether the device is within the home area or roaming.

In various embodiments, the method can be utilized on a device that is operable to control access to a wireless connection. In various embodiments, the device can be a pre-paid wireless device.

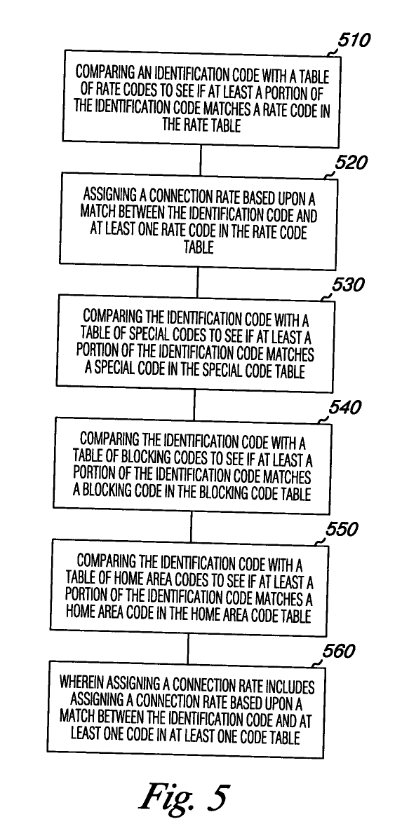

FIG. 5 illustrates a method embodiment for determining the classification of a wireless communication. In the embodiment shown in FIG. 5, the method includes comparing an identification code with a table of rate codes to see if at least a portion of the identification code matches a rate code in the rate table at block 510. In the embodiment illustrated in FIG. 5, the method includes assigning a connection rate based upon a match between the identification code and at least one rate code in the rate code table at block 520.

In the embodiment shown in FIG. 5, the method also includes, comparing the identification code with a table of special codes to see if at least a portion of the identification code matches a special code in the special code table at block 530. In the embodiment shown in FIG. 5, the method also includes comparing the identification code with a table of blocking codes to see if at least a portion of the identification code matches a blocking code in the blocking code table at block 540.

In the embodiment of FIG. 5, the method also includes comparing the identification code with a table of home area codes to see if at least a portion of the identification code matches a home area code in the home area code table at block 550. In the embodiment of FIG. 5, the method also provides assigning a connection rate based upon a match between the identification code and at least one code in at least one code table at block 560.

In various embodiments, the method illustrated in FIG. 5 can also include comparing a system identification code with a table of home identification codes to see if at least a portion of the system identification code matches a home identification code in the home identification code table.

In various embodiments the method can also include creating a rate table with having spaces allocated therein for entry of new data. In various embodiments the method can also include providing a wireless device having a rate table thereon and a set of computer executable software for comparing an identification code with rate codes within the rate table. In some embodiments, providing a wireless device having a rate table thereon can include providing a special code table, a blocking code table, and a home area code table as subsets within a collective table.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one.

Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. § 1.72(b) requiring an Abstract that will allow the reader to quickly ascertain the nature of the technical disclosure. It is submitted with the understanding that it will not be used to limit the scope of the claims.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A wireless device, comprising:
a processor;
a memory in communication with the processor;
a transceiver in communication with the processor and operable to transmit and receive information via a wireless connection;
wherein the device is operable to provide a wireless connection based upon a plan having a predetermined number of available units, wherein plan usage is tracked by a provider through use of a calculation method utilizing unit calculations that are not equal to exact time usage to decrement available units; and
wherein the device is operable to emulate the calculation method of the provider in order to track the remaining available units on the device.

2. The device of claim 1, wherein the device is operable to control access to the wireless connection and access is restricted when the device calculates there are no available units.

3. The device of claim 2, wherein the device is operable to accept a predetermined number of units entered into the device and the device unrestricts the access to the wireless connection.

4. The device of claim 1, wherein the device is operable to transmit and receive a wireless data connection and a wireless voice connection and wherein data and voice usage is tracked by the provider through use of a calculation method utilizing unit calculations that are not equal to exact time usage to decrement available units.

5. The device of claim 4, wherein the device is operable to emulate a plan wherein the wireless data and wireless voice connections have different calculation methods.

6. The device of claim 1, wherein the exact time usage is measured in seconds.

7. The device of claim 1, wherein the device is operable to switch from a first method of calculation to a second method of calculation while the device is connected to the wireless connection.

8. The device of claim 1, wherein the device is operable to transmit usage information to the provider.

9. A wireless device, comprising:
a processor;
a memory coupled to the processor;
a transceiver operable to transmit and receive information via a wireless connection;
wherein the transceiver is operable to receive a wireless connection;
wherein the device is operable to receive a provider roaming list having a number of connection locations, each connection location having at least one roaming characteristic associated therewith; and
wherein the device is operable to identify if the device is roaming based upon the roaming characteristic.

10. The wireless device of claim 9, wherein the device is operable to receive a provider roaming list having a first and a second roaming characteristic.

11. The system architecture of claim 10, wherein the device is operable to identify if the device is roaming based upon one of the roaming characteristics.

12. The system architecture of claim 10, wherein the device is operable to identify if the device is roaming based upon the first and second roaming characteristics.

13. A wireless device, comprising:
a transceiver operable to transmit and receive information via a wireless connection;
wherein the device is operable to transmit and receive a first type of wireless communication to a first provider and a second type of wireless communication to a second provider;
wherein the device is operable to conduct the first and second types of wireless connections based upon predetermined number of units to be used and wherein usage is determined by the first and second providers that determine a number of remaining units through use of a calculation method;
wherein the device includes a set of executable instructions operable to emulate a calculation method of the first provider.

14. The device of claim 13, wherein the device is operable to emulate a calculation method of the second provider.

15. The device of claim 13, wherein the device is operable to receive a calculated remaining amount of units from the second provider.

16. The device of claim 15, wherein the device is operable to receive a calculated remaining amount of units from the second provider by Short Message Service (SMS).

17. A wireless device, comprising:
a processor;
a memory coupled to the processor;
a transceiver operable to transmit and receive information via a wireless connection; and
wherein the device is operable to switch between a post-paid platform and a pre-paid platform.

18. The device of claim 17, wherein the device is operable to switch between a post-paid platform and a pre-paid platform by modification of software within the device.

19. The device of claim 18, wherein the modification of software within the device is provided by wireless transmission of data to the device.

20. A wireless system, comprising:
a wireless network operable to provide a wireless connection based upon a plan having a number of available units, wherein plan usage is tracked by the wireless network by utilizing a set of executable instructions operable to use a calculation method that uses unit calculations that are not equal to exact time usage to decrement available units; and
a wireless device operable to receive a wireless connection from the provider and to transmit and receive information via the wireless connection;
wherein the device includes a set of executable instructions operable to emulate the calculation method of the provider to track the remaining available units.

21. The system of claim 20, wherein the set of executable instructions operable to emulate the calculation method of the wireless network includes being operable to emulate a calculation method wherein the plan has a number of sets of units.

22. The system of claim 21, wherein the units of at least one of the sets of units are different from at least one other set of units.

23. The system of claim 21, wherein the emulation of a calculation method is operable to emulate a first calculation method for a first set of units and a second calculation method for a second set of units.

24. The system of claim 20, wherein the device is operable to receive a wireless connection provided based upon a plan for a predetermined period of time and wherein the device is operable to define a subset of units based upon a portion of the predetermined period of time.

25. The system of claim 20, wherein the wireless device is operable to block connection to the provider when the device calculates that there are no remaining units.

26. The system of claim 20, wherein the wireless device is operable to transmit and receive information from the Internet.

27. A method for emulating a wireless provider's post paid plan on a prepaid device, comprising:
assigning a first number of available units, of access to a wireless connection, to be decremented based upon usage during a first time interval;
assigning a second number of available units, of access to a wireless connection, to be decremented based upon usage during a second time interval;
decrementing the assigned first and second numbers of units;
restricting access to a wireless connection if the at least the first units have been decremented to zero; and
adding additional units to the first and second units to replenish the numbers of available units.

28. The method of claim 27, wherein the second time interval is within the first time interval.

29. The method of claim 27, wherein the first time interval is for anytime communication and the second time interval is for night and weekend communication.

30. The method of claim 27, wherein adding additional units to the first and second units to replenish the numbers of available units includes adding units before the first and second units have been decremented to zero.

31. The method of claim 30, wherein the method further includes holding the additional units in a separate account until a billing date passes and then adding the additional units to the first and second units.

32. The method of claim 30, wherein the method further includes decrementing the numbers of first and second units to zero after a period of time has passed since the units were assigned.

33. A method for determining the classification of a wireless communication, comprising:
comparing an identification code with a table of rate codes to see if at least a portion of the identification code matches a rate code in the rate table;
assigning a connection rate based upon a match between the identification code and at least one rate code in the rate code table; and
wherein the comparing an identification code with a table of rate codes includes comparing an identification code with a table of special rate codes to see if at least a portion of the identification code matches a special rate code in the special rate table.

34. The method of claim 33, wherein the comparing an identification code with a table of rate codes includes comparing the identification code with a table of blocking codes to see if at least a portion of the identification code matches a blocking code in the blocking code table.

35. The method of claim 33, wherein the method further includes comparing a system identification code with a table of home identification codes to see if at least a portion of the system identification code matches a home identification code in the home identification code table.

36. The method of claim 33, wherein the comparing an identification code with a table of rate codes includes comparing the identification code with a table of home area codes to see if at least a portion of the identification code matches a home area code in the home area code table.

37. The method of claim 33, wherein the identification code has a number of digits and wherein the rate codes have a number of digits and wherein a sequence of digits within the identification code are compared to see if the sequence of digits in the identification code match a sequence of digits in at least one rate code.

38. The method of claim 33, wherein the method is operable on a pre-paid wireless device.

39. A method for determining the classification of a wireless communication, comprising:
comparing an identification code with a table of rate codes to see if at least a portion of the identification code matches a rate code in the rate table;
comparing the identification code with a table of special codes to see if at least a portion of the identification code matches a special code in the special code table;
comparing the identification code with a table of blocking codes to see if at least a portion of the identification code matches a blocking code in the blocking code table;
comparing the identification code with a table of home area codes to see if at least a portion of the identification code matches a home area code in the home area code table; and
wherein assigning a connection rate includes assigning a connection rate based upon a match between the identification code and at least one code in at least one code table.

40. The method of claim 39, wherein the method further includes creating a rate table with having spaces allocated therein for entry of new data.

41. The method of claim 39, wherein the method further includes providing a wireless device having a rate table thereon and a set of computer executable software for comparing an identification code with rate codes within the rate table.

42. The method of claim 39, wherein providing a wireless device having a rate table thereon includes providing a special code table, a blocking code table, and a home area code table as subsets within a collective table.

43. The method of claim 39, wherein the method further includes comparing a system identification code with a table of home identification codes to see if at least a portion of the system identification code matches a home identification code in the home identification code table.
